(19) United States
(12) Patent Application Publication
(10) Pub. No.: US 2013/0021332 A1
(43) Pub. Date: Jan. 24, 2013

(54) IMAGE PROCESSING METHOD, IMAGE PROCESSING DEVICE AND DISPLAY DEVICE

(71) Applicants: Takuya OOI, Tokyo (JP); Yota KOMORIYA, Tokyo (JP); Takanori ISHIKAWA, Saitama (JP); Kentaro DOBA, Tokyo (JP); Tsutomu NIGAMI, Tokyo (JP)

(72) Inventors: Takuya OOI, Tokyo (JP); Yota KOMORIYA, Tokyo (JP); Takanori ISHIKAWA, Saitama (JP); Kentaro DOBA, Tokyo (JP); Tsutomu NIGAMI, Tokyo (JP)

(73) Assignee: Sony Corporation, Tokyo (JP)

(21) Appl. No.: 13/546,682

(22) Filed: Jul. 11, 2012

(30) Foreign Application Priority Data
Jul. 21, 2011 (JP) 2011-159802

(51) Int. Cl. G06T 15/00

(52) U.S. Cl. 345/419

(57) ABSTRACT

An image processing method is provided that includes: acquiring an original image; and with respect to pixels in an area which is within the acquired original image and from which parallax information is not extracted or acquired, generating the parallax information of the pixels in the area in accordance with a magnitude relation of the parallax information of at least two pixels which are adjacent or close to the pixels in the area and which are included among pixels from which the parallax information is extracted or acquired.

### CROSS REFERENCES TO RELATED APPLICATIONS

The present application claims priority to Japanese Priority Patent Application JP 2011-159802 filed in the Japan Patent Office on Jul. 21, 2011, the entire content of which is hereby incorporated by reference.

### BACKGROUND

The present disclosure relates to an image processing method, an image processing device and a display device.

It is known that an interpolation image in a desired generation phase is generated using stereo images (original images) of a left eye image (an L image) and a right eye image (an R image) and parallax information. The generated interpolation image is displayed, as a single viewpoint image within a multi-viewpoint image, at a predetermined position on a display device that allows stereoscopic viewing.

The parallax information of the original images indicates information about a depth direction of a stereoscopic image. For example, the parallax information of the original images can be obtained by extracting, as disparity, a displacement amount in a horizontal direction of the L image and the R image. The disparity is used when generating interpolation images that are interpolated between stereo images. However, when the interpolation image is generated using disparity maps that are extracted from the L image and the R image, there are cases in which an interpolation error occurs due to a disparity extraction error. One example of the interpolation error is a case in which coordinates of the interpolation image where pixels representing the foreground have already been drawn are overwritten by pixels representing the background. As a result, the foreground is eroded by a part of the interpolation image and image quality of the interpolation image deteriorates.

To address this, Japanese Patent Application Publication No. JP-A-2010-78768 discloses a technique in which, when an image is generated using the disparity, writing is performed starting from a pixel having a larger depth value, namely, a pixel having a deeper depth, thus avoiding overwriting of the pixels of the foreground by the pixels of the background.

### SUMMARY

However, with the technique disclosed in Japanese Patent Application Publication No. JP-A-2010-78768, a comparison of disparity magnitude is performed for each of the pixels in the original images. As a result, a processing load is increased and this technique is not efficient.

Further, for example, when the disparity between the L image and the R image is extracted by dynamic programming (DP) matching, if an object is drawn in each of the original images L and R as shown in FIG. 1, areas La and Lb of disparity maps L and R of the L image and the R image are occlusion areas where there is no corresponding relationship between left and right images of the L image and the R image. Therefore, generally in the occlusion areas, there is a high possibility that disparity values are not obtained or an error occurs. Accordingly, in this type of case, even if the disparity magnitude comparison is performed for all the pixels in the original images as disclosed in Japanese Patent Application Publication No. JP-A-2010-78768, there is a high possibility that an extraction error occurs in the disparity itself. As a result, the phenomenon in which the pixels of the foreground are overwritten by the pixels of the background cannot be completely avoided.

Given this, an image processing method, an image processing device and a display device are demanded that can reduce a disparity extraction error and that can generate a high quality image.

According to an embodiment of the present disclosure, there is provided an image processing method that includes: acquiring an original image; and with respect to pixels in an area which is within the acquired original image and from which parallax information is not extracted or acquired, generating the parallax information of the pixels in the area in accordance with a magnitude relation of the parallax information of at least two pixels which are adjacent or close to the pixels in the area and which are included among pixels from which the parallax information is extracted or acquired.

According to another embodiment of the present disclosure, there is provided an image processing device that includes: an acquisition portion that acquires an original image; and a generation portion that, with respect to pixels in an area which is within the acquired original image and from which parallax information is not extracted or acquired, generates the parallax information of the pixels in the area in accordance with a magnitude relation of the parallax information of at least two pixels which are adjacent or close to the pixels in the area and which are included among pixels from which the parallax information is extracted or acquired.

According to another embodiment of the present disclosure, there is provided a display device that includes: an acquisition portion that acquires an original image; a generation portion that, with respect to pixels in an area which is within the acquired original image and from which parallax information is not extracted or acquired, generates the parallax information of the pixels in the area in accordance with a magnitude relation of the parallax information of at least two pixels which are adjacent or close to the pixels in the area and which are included among pixels from which the parallax information is extracted or acquired; and a display control portion that controls display of the original image using the generated parallax information.

As explained above, according to the image processing of an embodiment of the present disclosure, it is possible to reduce a disparity extraction error and to generate a high quality image.

Additional features and advantages are described herein, and will be apparent from the following Detailed Description and the figures.

### BRIEF DESCRIPTION OF THE FIGURES

FIG. 1 is a diagram showing occlusion areas within disparity maps;

FIG. 2 is a diagram illustrating an occlusion area interpolation method according to a comparative example and an occlusion area interpolation method according to an embodiment of the present disclosure;

FIG. 3 is a diagram showing results obtained by interpolating the occlusion areas using the interpolation methods shown in FIG. 2;

FIG. 4 is a functional configuration diagram of an image processing device according to the embodiment of the present disclosure;

FIG. 5 is a flowchart showing image processing that is performed in the embodiment of the present disclosure;

FIG. 6 is a flowchart showing disparity map generation processing that is performed in the embodiment of the present disclosure;

FIG. 7 is a diagram showing an example of disparity values before and after interpolation;

FIG. 8 is a diagram illustrating an occlusion area interpolation method according to a first modified example;

FIG. 9 is a diagram illustrating the interpolation method according to the first modified example;

FIG. 10 is a diagram illustrating an occlusion area interpolation method according to a second modified example; and

FIG. 11 is a diagram illustrating the interpolation method according to the second modified example.

### DETAILED DESCRIPTION

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the explanation will be made in the following order.

1. Introduction
1.1. Disparity and occlusion

2. Embodiment of the present disclosure
2.1. Comparison of occlusion area interpolation methods
2.2. Comparison results
2.3. Functions of image processing device
2.4. Operations of image processing device
2.5. Examples of advantageous effects

3. First modified example

4. Second modified example

### 1. INTRODUCTION

1.1. Disparity and Occlusion

First, disparity and an occlusion area will be briefly explained. Parallax information of an L image and an R image, which are original images, indicates information about a depth direction of a stereoscopic image. For example, the parallax information can be obtained by extracting, as disparity, a displacement amount in a horizontal direction of the L image and the R image. Note that although, hereinafter, disparity maps are extracted as the parallax information, a map format need not necessarily be used. Further, the parallax information is not limited to the disparity that indicates the displacement amount in the horizontal direction of the L image and the R image, and it may be information indicating a displacement amount in a vertical direction of the L image and the R image or other depth information.

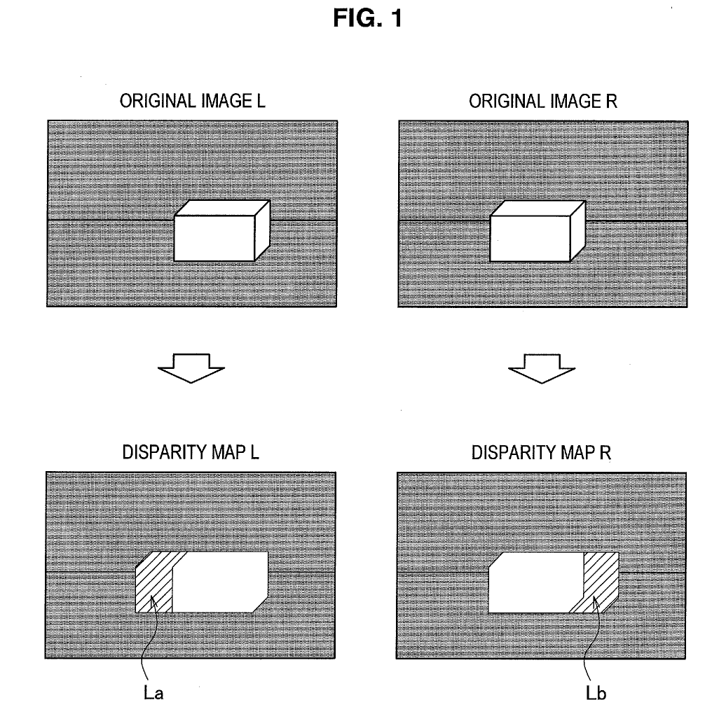

For example, when DP matching is used to generate disparity maps of the L image and the R image, areas La and Lb of disparity maps L and R shown in FIG. 1 are occlusion areas, namely, areas that cannot be visually recognized by a camera because an object exists in the foreground. In this type of occlusion area, there is no corresponding relationship between left and right images of the L image and the R image. Therefore, in the occlusion areas, generally, there is a high possibility that disparity values are not obtained (in this case, an initial value is set as the disparity values) or an error occurs. Therefore, when an interpolation image is generated, calculation for image generation cannot be performed in the first place and the interpolation image is degraded. In this manner, if the interpolation image is generated using the disparity values of the occlusion areas as they are, there occurs not only a phenomenon that pixels of the foreground are overwritten by pixels of the background, but also a phenomenon that the interpolation image is degraded. To address this, hereinafter, first, an occlusion area interpolation method to further reduce a disparity extraction error will be explained.

### 2. EMBODIMENT OF THE PRESENT DISCLOSURE

2.1. Comparison of Occlusion Area Interpolation Methods

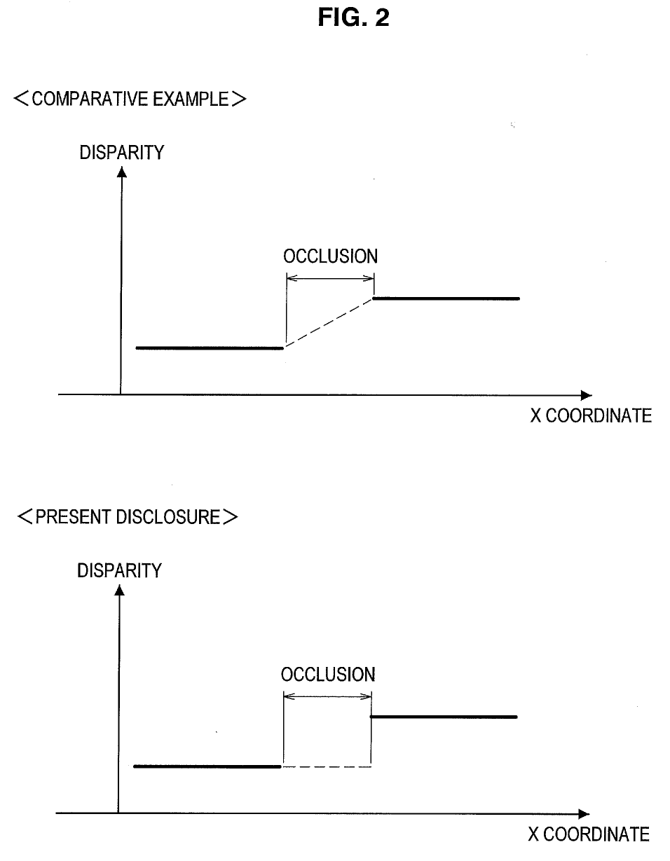

FIG. 2 is a diagram showing disparity values with respect to X coordinates on a given line in the horizontal direction of an original image. The upper section in FIG. 2 shows an interpolation method according to a comparative example and the lower section in FIG. 2 shows an interpolation method according to an embodiment of the present disclosure. In the comparative example shown in the upper section, the occlusion area is linearly connected to left and right disparity values of the occlusion area, and the disparity of the occlusion area is estimated by this linear interpolation.

On the other hand, in the embodiment of the present disclosure shown in the lower section, areas to the left and right of the occlusion area are searched and left and right disparity values are acquired. A disparity value that indicates a deeper depth is identified based on a magnitude relation between the acquired left and right disparity values, and the identified value is set as a disparity value of the occlusion area. In the embodiment of the present disclosure, it is defined that a smaller value among the left and right disparity values indicates the deeper depth. Therefore, the smaller value among the left and right disparity values (the left disparity value in FIG. 2, for example) is estimated as the disparity value of the occlusion area.

Note that the magnitude relation between the disparity values and a determination about the foreground or the background change depending on how to define a numeric value that indicates the disparity value. For example, in contrast to the present embodiment, if the disparity value is defined such that a numeric value indicating the foreground is smaller than a numeric value indicating the background, a relationship between the above-described control and the magnitude relation between the disparity values is reversed. More specifically, since a larger value among the left and right disparity values indicates the deeper depth, the larger value among the left and right disparity values (the right disparity value in FIG. 2, for example) is estimated as the disparity value of the occlusion area.

Note that, although only a single horizontal line of the disparity map is shown in FIG. 2, disparity extraction processing is performed for a number of horizontal lines included in the original image and interpolation processing is performed for each of the lines where the occlusion area exists.

2.2. Comparison Results

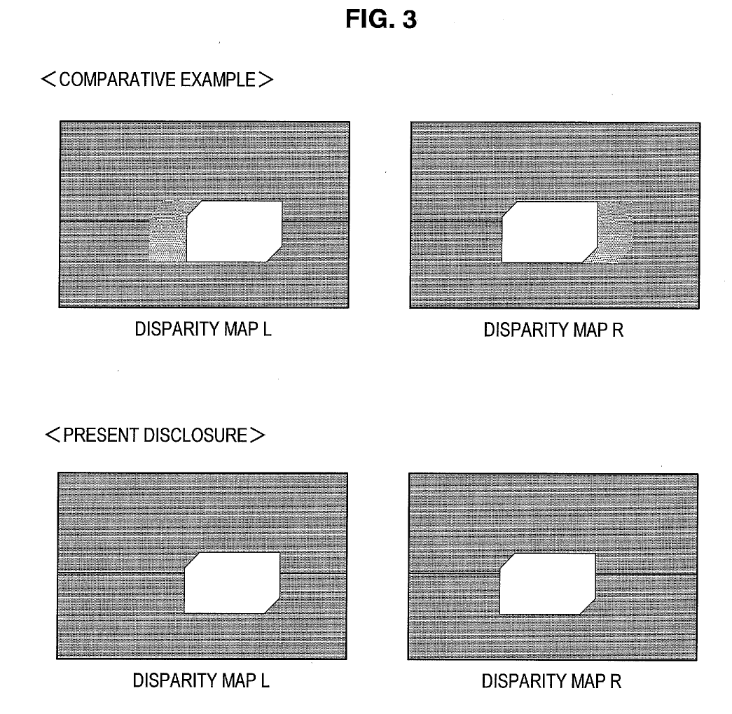

FIG. 3 shows results obtained by using the two occlusion area interpolation methods shown in FIG. 2. When the results are compared, in the case of the comparative example shown in the upper section, boundary lines between the background and the object in the foreground are blurred in the occlusion areas. In contrast to this, in the case of the embodiment of the present disclosure shown in the lower section, boundary lines between the background and the object in the foreground are clear, and the foreground is not overwritten by the background, thus avoiding a disparity extraction error. Based on the above, it is found that, when the occlusion area interpolation method according to the embodiment of the present disclosure is used, it is possible to more accurately identify the disparity value of the occlusion area and to generate a high quality image.

Given this, hereinafter, functions and operations of an image processing device that uses the occlusion area interpolation method (the image processing method) according to the embodiment of the present disclosure will be explained in order.

2.3. Functions of Image Processing Device.

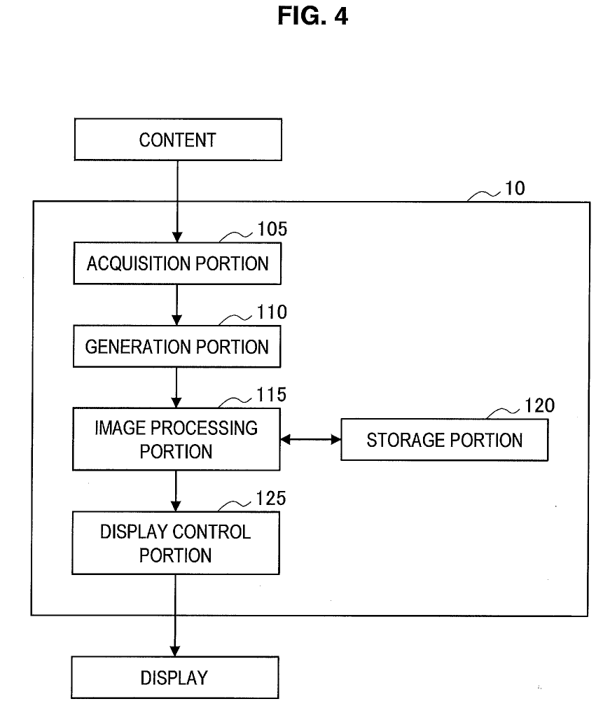

First, a functional configuration of an image processing device 10 according to the embodiment of the present disclosure will be explained with reference to FIG. 4. The image processing device 10 according to the embodiment of the present disclosure includes an acquisition portion 105, a generation portion 110, an image processing portion 115, a storage portion 120 and a display control portion 125.

The acquisition portion 105 acquires stereo images (original images) of the L image and the R image of content. Content information that can be acquired includes video signals of the stereo images only, or video signals of the stereo images and disparity information, as in computer graphics (CG).

When the acquisition portion 105 acquires the L image and the R image, the generation portion 110 extracts disparity values based on a displacement amount in the horizontal direction of the L image and the R image and generates disparity maps.

Note that the disparity maps are an example of parallax information, and a map format need not necessarily be used for the parallax information. The generation portion 110 performs interpolation processing on pixels in the occlusion area from which the disparity is not extracted or acquired, of the acquired stereo images. More specifically, the generation portion 110 identifies the disparity of the pixels in the occlusion area in accordance with a magnitude relation between disparity values of the left and right pixels that are adjacent to the occlusion area.

Note that, also when the acquisition portion 105 acquires the disparity along with the stereo images, if the occlusion area exists, the generation portion 110 extracts the disparity according to the interpolation method of the present embodiment. By doing this, it is possible to reduce a disparity extraction error and to generate a high quality image.

The image processing portion 115 generates an interpolation image in a desired phase (a generation phase) from the stereo images of the L image and the R image and from the disparity maps of the respective images.

The storage portion 120 stores the generated disparity maps and interpolation image.

The display control portion 125 controls display of the original image and the interpolation image using the generated disparity value. By doing this, it is possible to display a multi-viewpoint image on a display in a stereoscopic manner. Note that the display need not necessarily display content of the generated multi-viewpoint image in a stereoscopic manner, and the display may perform 2D display. The display may be a display that can switch between 3D display and 2D display, or may be a display that can simultaneously perform 3D display and 2D display for each of predetermined areas.

Note that functions of the generation portion 110, the image processing portion 115 and the display control portion 125 can be achieved, for example, by a central processing unit (CPU) (not shown in the drawings) operating according to a program stored in the storage portion 120. The program may be a program which is provided by being stored in a storage medium and which is read into the storage portion 120 via a driver (not shown in the drawings). Further, the program may be a program that is downloaded from a network and is stored in the storage portion 120. Further, in order to achieve the functions of the above-described respective portions, a digital signal processor (DSP) may be used instead of the CPU. The storage portion 120 can be realized as, for example, a semiconductor memory, a magnetic disc, or a random access memory (RAM) or a read only memory (ROM) that uses an optical disc etc. Further, the functions of the above-described respective portions may be achieved such that the respective portions operate using software or may be achieved such that the respective portions operate using hardware.

2.4. Operations of Image Processing Device

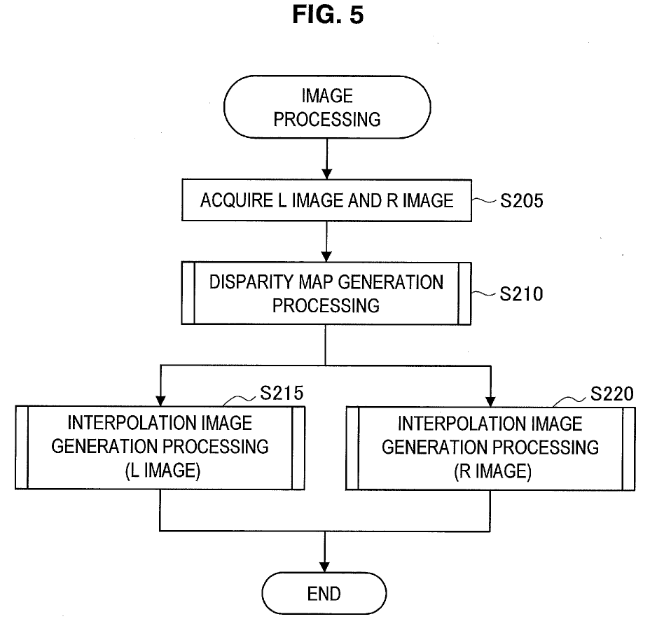

Next, operations of the image processing device 10 according to the embodiment will be explained with reference to FIG. 5. FIG. 5 is a flowchart showing image processing according to the embodiment of the present disclosure.

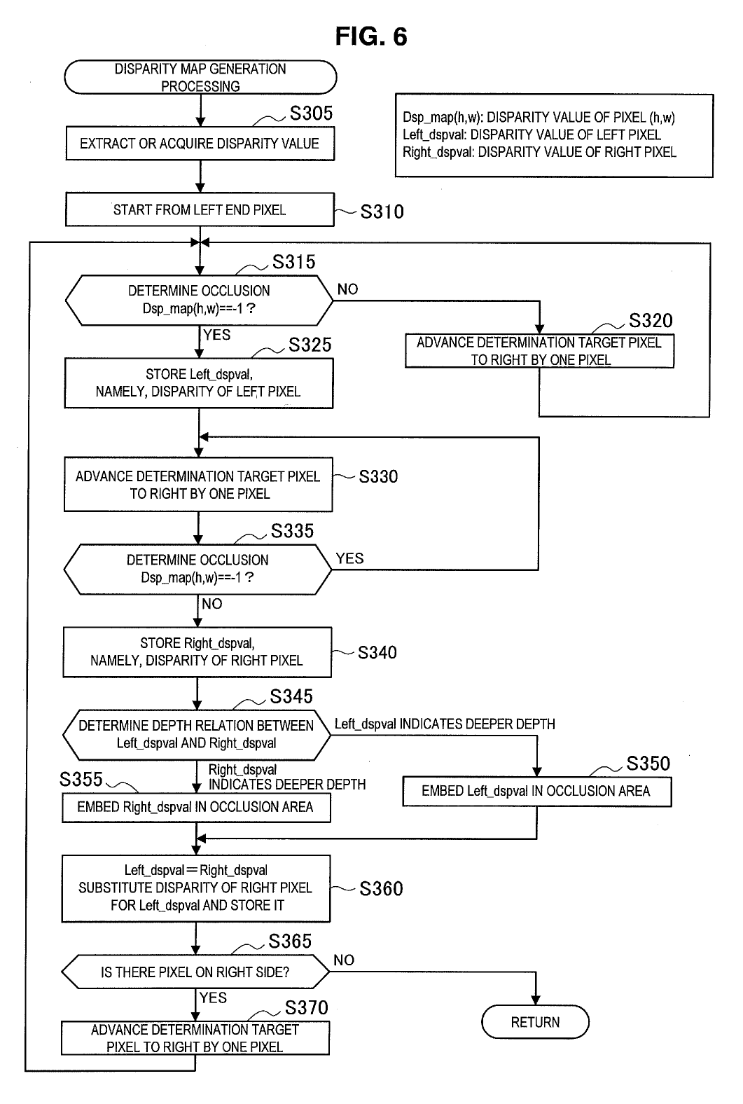

When the image processing starts, at step S205, the acquisition portion 105 acquires stereo images of the L image and the R image. Next, at step S210, the generation portion 110 generates disparity maps from the L image and the R image. FIG. 6 shows specific generation processing.

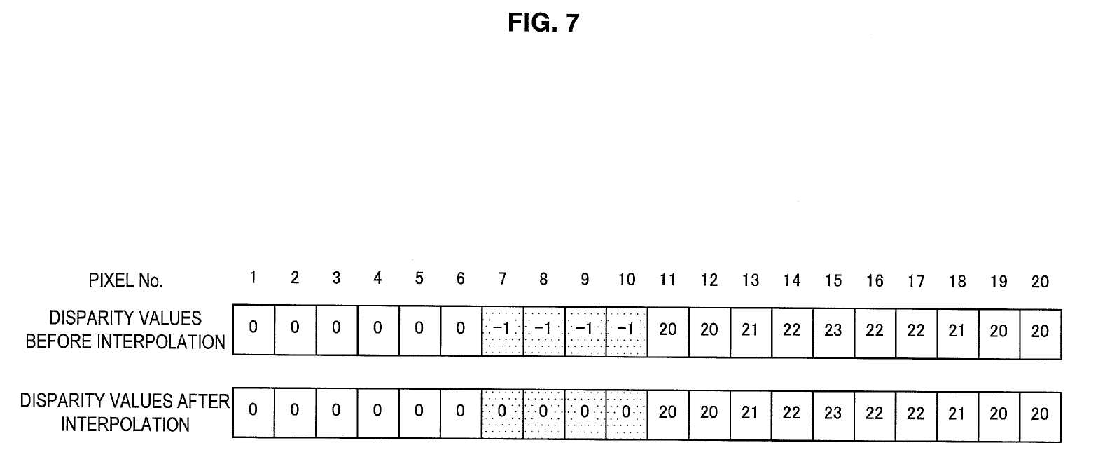

In disparity map generation processing, at step S305, the generation portion 110 extracts the disparity or inputs the disparity value acquired by the acquisition portion 105. For example, the generation portion 110 generates a disparity map of the L image and a disparity map of the R image. For example, the upper section of FIG. 7 shows disparity values of the L image (or the R image) before interpolation with respect to the occlusion area. The disparity indicates a displacement amount between the L image and the R image. Therefore, for example, if the disparity value is “20”, this indicates that video information of the L image corresponding to the disparity indicated by “20” and video information of the R image corresponding to the disparity indicated by “20” of the R image, which is displaced by 20 pixels in the horizontal direction from coordinates of the L image, are the same video. Further, in the present embodiment, the disparity value “0” indicates the background and indicates that there is no displacement between the L image and the R image. An image that corresponds to a disparity value that is larger than “0” indicates the foreground. Further, although in the present embodiment, an initial value of each of the disparity values is set to “−1”, the initial value is not limited to this example.

At step S310, the processing is started from a left end pixel. For example, with respect to a horizontal line (the disparity values before interpolation) shown in the upper section of FIG. 7, the disparity of the left end pixel whose pixel number (pixel No.) is “1” is extracted. At step S315, the generation portion 110 determines whether or not the left end pixel is in the occlusion area. The determination as to whether or not the left end pixel is in the occlusion area is determined based on whether or not the disparity value is the initial value “−1”. In the occlusion area, there is no image that corresponds to one of the L image and the R image. Therefore, the occlusion area is an area where the disparity value cannot be generated, and thus the disparity value remains as the initial value “−1”.

Therefore, when it is determined that the disparity value is not “−1”, the generation portion 110 determines that a determination target pixel is located outside the occlusion area and there is no need to perform the interpolation processing. Then at step S320, the generation portion 110 advances the determination target pixel to the right by one pixel. In this manner, until it is determined that the disparity value is “−1”, the generation portion 110 repeats the processing at step S315 and step S320 while advancing the determination target pixel to the right by one pixel.

With respect to the horizontal line shown in the upper section of FIG. 7, the generation portion 110 repeats the processing at step S315 and step S320 until the pixel No. reaches “7”. When the pixel No. reaches “7”, the generation portion 110 determines that the disparity value is “−1”, and the processing proceeds to step S325 in order to perform the interpolation processing for the disparity value of the occlusion area.

At step S325, first, in order to compare the magnitudes of the disparity values of the left and right pixels that are adjacent to the occlusion area, the generation portion 110 stores, as Left_dspval, the disparity value of the left side pixel that is adjacent to the occlusion area, namely, the pixel No. 6. Next, at step S330, the generation portion 110 advances the determination target pixel to the right by one pixel. At step S335, the generation portion 110 determines whether or not the determination target pixel is located in the occlusion area. When it is determined that the disparity value is “−1”, the determination target pixel is located in the occlusion area, and therefore, the processing returns to step S330. Until it is determined that the disparity value is not “−1”, the generation portion 110 repeats the processing at step S330 and step S335 while advancing the determination target pixel to the right by one pixel.

When it is determined that the disparity value is not “−1”, the processing proceeds to step S340 and the generation portion 110 stores, as Right_dspval, the disparity value of the right side pixel that is adjacent to the occlusion area, namely, the pixel No. 11. Next, at step S345, the generation portion 110 compares the magnitudes of the disparity values, Left_dspval and Right_dspval, of the left and right pixels that are adjacent to the occlusion area. When the determination result is that the value of Left_dspval is smaller than the value of Right_dspval, the generation portion 110 determines that the left side pixel that is adjacent to the occlusion area is the background and the right side pixel that is adjacent to the occlusion area is the foreground. The processing proceeds to step S350 and the value of Left_dspval that is determined as the background is substituted for the disparity value of the occlusion area. On the other hand, when the determination result is that the value of Right_dspval is smaller than the value of Left_dspval, the generation portion 110 determines that the right side pixel that is adjacent to the occlusion area is the background and the left side pixel that is adjacent to the occlusion area is the foreground. The processing proceeds to step S355 and the value of Right_dspval that is determined as the background is substituted for the disparity value of the occlusion area.

In the case of the upper section of FIG. 7, the value of Left_dspval of the pixel No. 6 is “0” and the value of Right_dspval of the pixel No. 11 is “20”. Accordingly, the generation portion 110 determines that the left side pixel No. 6 that is adjacent to the occlusion area is the background and the right side pixel No. 11 that is adjacent to the occlusion area is the foreground, and the generation portion 110 substitutes the value “0” of Left_dspval that is determined as the background, for the disparity value of the occlusion area. As a result, the disparity values of the occlusion area after interpolation shown by the horizontal line in the lower section of FIG. 7 have been changed to “0” that is the same value as the left side pixel No. 6 that is adjacent to the occlusion area. As a result, it is possible to avoid overwriting of the foreground by the background in the occlusion area due to a disparity extraction error of the occlusion area, and to avoid erosion of the foreground.

Next, the processing proceeds to step S360 shown in FIG. 6. In the occlusion area, the generation portion 110 substitutes the disparity value of the right pixel of the occlusion area for the disparity value Left_dspval of the left pixel, and stores it. Next, the processing proceeds to step 5365 and the generation portion 110 determines whether or not there is a pixel located further to the right on the same line. When there is a pixel, the generation portion 110 advances the determination target pixel to the right by one pixel at step S370, and the processing returns to step S315. Until it is determined at step S365 that there is no pixel that is located further to the right on the same line, the generation portion 110 repeats the processing from step S315 to step S370. When it is determined at step S365 that there is no pixel that is located further to the right on the same line, the generation portion 110 ends this processing.

Returning to FIG. 5, after the above occlusion area interpolation processing is applied to the disparity map generation of the L image and the R image, interpolation image generation processing of the L image at step S215 and interpolation image generation processing of the R image at step S220 are performed. Specifically, the image processing portion 115 generates an interpolation image in a desired phase (a generation phase) from the stereo images of the L image and the R image and from the disparity maps of the respective images, and ends this image processing. The generated disparity maps and interpolation image are stored in the storage portion 120.

2.5. Examples of Advantageous Effects

As described above, there is a high possibility that the disparity value is not accurately obtained in the occlusion area. On the other hand, there is a high possibility that the occlusion area is a background area that is hidden by an object in the foreground. Based on this principle, the areas to the left and right of the occlusion area are searched and disparity effective areas that are adjacent to the occlusion area are identified. Then, among the disparity values of the left and right disparity effective areas, the disparity value indicating the deeper depth is substituted for the disparity value of the occlusion area.

In this manner, the disparity value indicating the deeper depth is identified based on the magnitude relation between the left and right disparity values, and the identified disparity value is set as the disparity value of the occlusion area. Thus, for example, as shown in FIG. 3, the boundary lines between the background and the object in the foreground become clear and the foreground is not overwritten by the background, thereby reducing a disparity extraction error. Accordingly, with the occlusion area interpolation method according to the embodiment of the present disclosure, it is possible to more accurately identify the disparity value of the occlusion area and it is possible to generate and display a high quality image.

Note that, in the present embodiment, the areas to the left and right of the occlusion area are searched, and based on the magnitude relation between the disparity values of the pixels (the pixel No. 6 and the pixel No. 11 in FIG. 7) in the disparity effective areas that are adjacent to the occlusion area, the disparity value indicating the deeper depth is substituted for the disparity value of the occlusion area. However, without being limited to this example, among the disparity values of the pixels (for example, the pixel No. 5 and the pixel No. 12 in FIG. 7) that are close to the occlusion area, the disparity value indicating the deeper depth may be substituted for the disparity value of the occlusion area.

Further, in the present embodiment, the areas to the left and right of the occlusion area are searched. However, without being limited to this example, areas above and below the occlusion area may be searched, and based on the magnitude relation between the disparity values of the pixels that are adjacent or close to the occlusion area, the disparity value indicating the deeper depth may be substituted for the disparity value of the occlusion area.

### 3. FIRST MODIFIED EXAMPLE

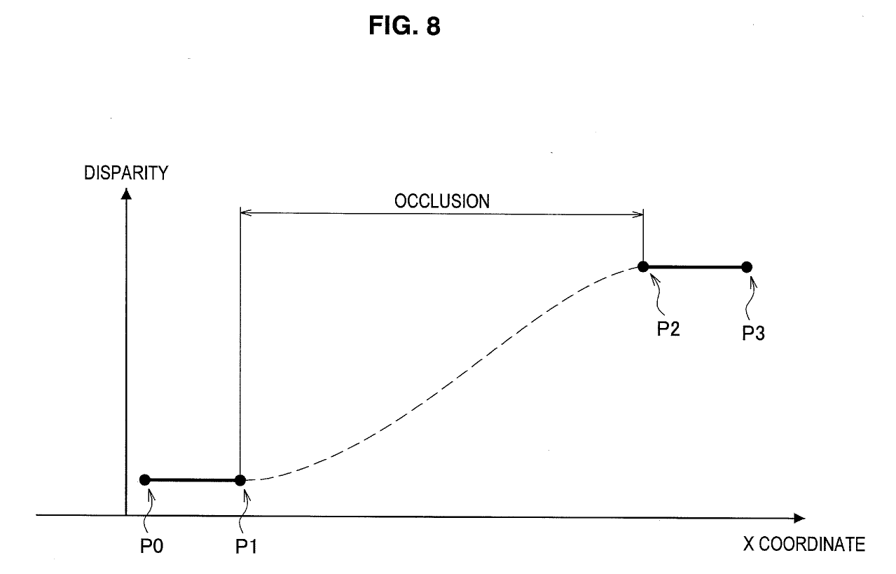

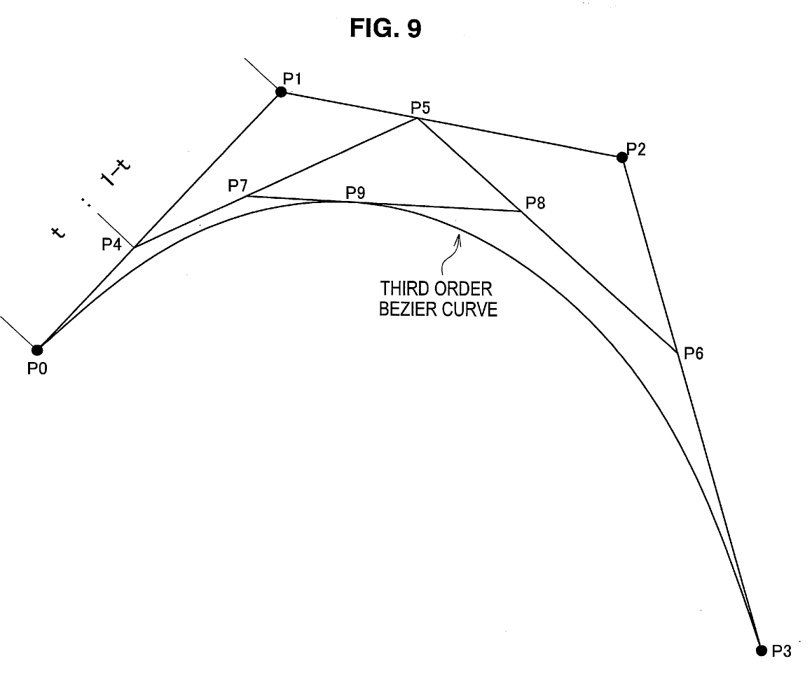

Hereinafter, a first modified example of the above-described embodiment of the present disclosure will be explained with reference to FIG. 8 and FIG. 9. In the above-described embodiment of the present disclosure, as shown in the lower section of FIG. 2, all the disparity values in the occlusion area are set to the same value as the disparity value indicating the deeper depth among the left and right disparity values. However, as in the first modified example shown in FIG. 8, the disparity values of the occlusion area may be interpolated using a Bezier curve.

Specifically, the generation portion 110 uses the occlusion area and disparity values (disparity values of coordinates of points P0, P1, P2 and P3) on both the ends of the occlusion area to interpolate the occlusion area using the Bezier curve. Here, an algorism of the Bezier curve will be explained while referring to FIG. 9, in which a third order Bezier curve that is represented by the four control points P0, P1, P2 and P3 is used.

The points P0, P1, P2 and P3 are the given control points. Here, in order to obtain coordinates of a point at a position of a ratio of t (0<t<1) from the point P0 of the Bezier curve, the following calculation is performed.

1. First, points P4, P5 and P6 that divide three line segments P0-P1, P1-P2 and P2-P3 respectively at a ratio of t:1-t are calculated. The three line segments are obtained by sequentially connecting the control points.

2. Next, points P7 and P8 that divide two line segments P4-P5 and P5-P6 respectively, again at the ratio of t:1-t are calculated. The two line segments are obtained by sequentially connecting the points P4, P5 and P6.

3. Lastly, a point P9 that divides a line segment P7-P8, which connects the two points P7 and P8, again at the ratio of t:1-t is calculated. The calculated point P9 is set to a point on the Bezier curve.

4. The processing from 1 to 3 is repeatedly performed in a range of 0<t<1, and thus the third order Bezier curve having the control points P0, P1, P2 and P3 is obtained.

According to the first modified example, a depth change can be smoothly expressed as compared to the method according to the present embodiment that interpolates the occlusion area using a horizontal line or the method according to the comparative example that interpolates the occlusion area using an oblique linear line. Even when a disparity extraction error occurs in the occlusion area, the disparity values do not change rapidly and it is therefore possible to obscure an error in the interpolation image. Further, as compared to the method according to the comparative example that interpolates the occlusion area using an oblique linear line, it is possible to reduce the possibility that the foreground is overwritten by the background and it is possible to reduce the disparity extraction error. At the same time, even when the inclination of the linear line has a large value due to a difference between the disparity values on both the ends of the occlusion area, the interpolation can be performed smoothly.

### 4. SECOND MODIFIED EXAMPLE

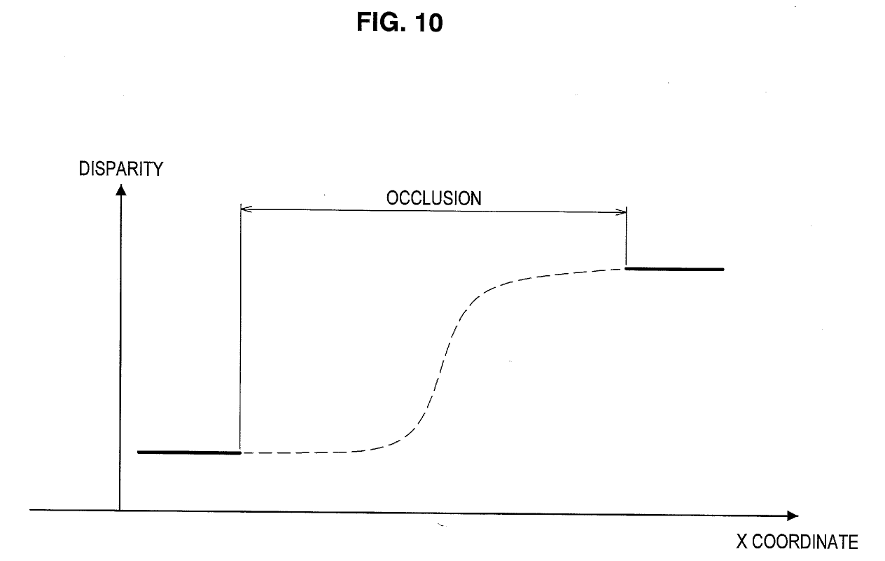

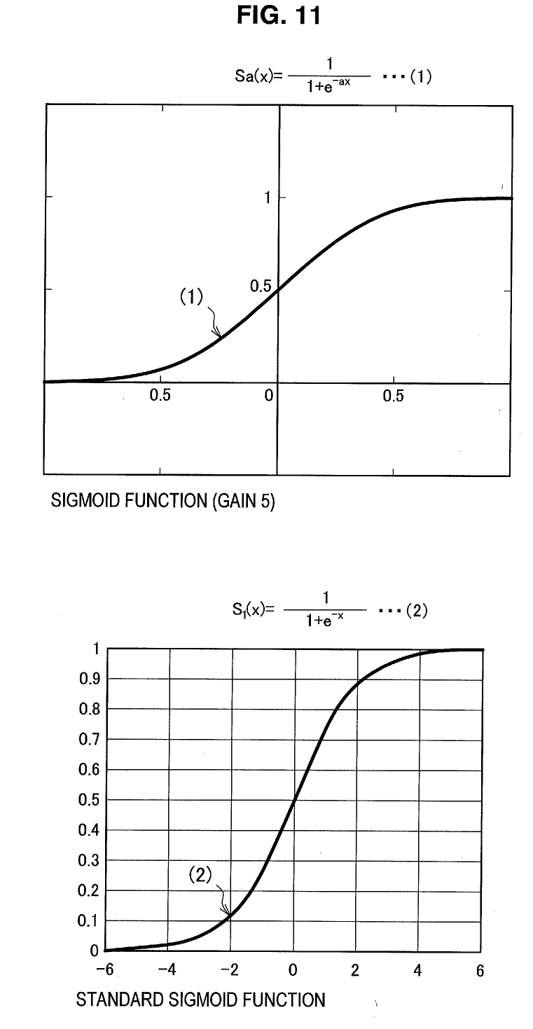

Hereinafter, a second modified example of the above-described embodiment of the present disclosure will be explained with reference to FIG. 10 and FIG. 11. In the first modified example, the Bezier curve is used to estimate the disparity values of the occlusion area. In contrast to this, in the second modified example, a sigmoid curve is used to estimate the disparity values of the occlusion area, as shown in FIG. 10.

Here, the sigmoid curve will be explained. A sigmoid function is a real function that is represented by Expression (1) in FIG. 11, and is represented by a curve in a graph shown in the upper section of FIG. 11 (a sigmoid curve when a gain is 5). Note that, “a” in Expression (1) is called the gain.

In a narrow sense, the sigmoid function indicates a standard sigmoid function where the gain “a” represented by Expression (2) in FIG. 11 is 1. The standard sigmoid function is represented by a curve in a graph shown in the lower section of FIG. 11.

Hereinafter, the sigmoid function in a broader sense of the term will be described. With respect to the standard sigmoid function, a=1 may be substituted.

The term sigmoid is also referred to as a sigmoid curve, and means a shape similar to that of the Greek character sigma σ (“S” in Expression (1) and Expression (2)). Note that, when simply the term sigmoid or sigmoid curve is used, normally it collectively refers to functions (a cumulative normal distribution function, a Gompertz function and the like) of a type having similar characteristics to those of the sigmoid function.

According to the second modified example, when the inclination of both the ends of the occlusion area is flat, the occlusion area can be smoothly interpolated and a depth change can be smoothly expressed as compared to the method in which the occlusion area is interpolated using a horizontal line or an oblique linear line. Therefore, even when it is assumed that object boundaries on both the ends of the occlusion area are located in the center of the occlusion area, it is possible to obscure a generation error of the interpolation image and it is possible to generate an interpolation image having a higher image quality.

Hereinabove, the exemplary embodiment of the present disclosure is explained in detail with reference to the appended drawings. However, the technical scope of the present disclosure is not limited to the above-described examples. It should be understood by those skilled in the art that various modifications, combinations, sub-combinations and alterations may occur depending on design requirements and other factors insofar as they are within the scope of the appended claims or the equivalents thereof.

For example, in the above-described embodiment, the displacement amount in the horizontal direction is extracted as the disparity. However, the present disclosure is not limited to this example. For example, in the present disclosure, the displacement amount in the vertical direction may be extracted as the disparity.

For example, in the above-described embodiment, the left eye image (the L image) and the right eye image (the R image) are an example of the original images. However, the present disclosure is not limited to this example, and it is sufficient if the original images are two images that are captured at different angles.

Additionally, the present application may also be configured as below.

(1) An image processing method including:

acquiring an original image; and

with respect to pixels in an area which is within the acquired original image and from which parallax information is not extracted or acquired, generating the parallax information of the pixels in the area in accordance with a magnitude relation of the parallax information of at least two pixels which are adjacent or close to the pixels in the area and which are included among pixels from which the parallax information is extracted or acquired.

(2) The image processing method according to (1), wherein

with respect to the pixels in the area which is within the acquired original image and from which the parallax information is not extracted or acquired, the parallax information of the pixels in the area is generated in accordance with a magnitude relation of the parallax information of pixels on both ends which are adjacent to the pixels in the area and which are included among pixels from which parallax information of a same line as that of the pixels in the area is extracted or acquired.

(3) The image processing method according to (1) or (2), further including:

determining, based on the magnitude relation of the parallax information, a front-rear relation in a depth direction of video information of pixels on both sides that are adjacent or close to the pixels in the area,

wherein when it is determined that the video information of the pixel on one of the sides is further in the background than the video information of the pixel on another of the sides, the parallax information of the pixel on the one of the sides is used as the parallax information of the pixels in the area.

(4) The image processing method according to any one of (1) to (3), wherein

the parallax information of the pixels in the area is generated for each of lines in a horizontal direction of the acquired original image.

(5) The image processing method according to any one of (1) to (4), wherein

a disparity map in accordance with the acquired original image is created by generating the parallax information of the pixels in the area.

(6) The image processing method according to any one of (1), (2), (4), and (5), wherein

based on the magnitude relation of the parallax information, the parallax information of the pixels in the area is generated using one of a Bezier curve and a sigmoid curve.

(7) An image processing device including:

an acquisition portion that acquires an original image; and

a generation portion that, with respect to pixels in an area which is within the acquired original image and from which parallax information is not extracted or acquired, generates the parallax information of the pixels in the area in accordance with a magnitude relation of the parallax information of at least two pixels which are adjacent or close to the pixels in the area and which are included among pixels from which the parallax information is extracted or acquired.

(8) A display device including:

an acquisition portion that acquires an original image; a generation portion that, with respect to pixels in an area which is within the acquired original image and from which parallax information is not extracted or acquired, generates the parallax information of the pixels in the area in accordance with a magnitude relation of the parallax information of at least two pixels which are adjacent or close to the pixels in the area and which are included among pixels from which the parallax information is extracted or acquired; and

a display control portion that controls display of the original image using the generated parallax information.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An image processing method comprising:
acquiring an original image; and
with respect to pixels in an area which is within the acquired original image and from which parallax information is not extracted or acquired, generating the parallax information of the pixels in the area in accordance with a magnitude relation of the parallax information of at least two pixels which are adjacent or close to the pixels in the area and which are included among pixels from which the parallax information is extracted or acquired.

2. The image processing method according to claim 1, wherein
with respect to the pixels in the area which is within the acquired original image and from which the parallax information is not extracted or acquired, the parallax information of the pixels in the area is generated in accordance with a magnitude relation of the parallax information of pixels on both ends which are adjacent to the pixels in the area and which are included among pixels from which parallax information of a same line as that of the pixels in the area is extracted or acquired.

3. The image processing method according to claim 1, further comprising:
determining, based on the magnitude relation of the parallax information, a front-rear relation in a depth direction of video information of pixels on both sides that are adjacent or close to the pixels in the area,
wherein when it is determined that the video information of the pixel on one of the sides is further in the background than the video information of the pixel on another of the sides, the parallax information of the pixel on the one of the sides is used as the parallax information of the pixels in the area.

4. The image processing method according to claim 1, wherein
the parallax information of the pixels in the area is generated for each of lines in a horizontal direction of the acquired original image.

5. The image processing method according to claim 1, wherein
a disparity map in accordance with the acquired original image is created by generating the parallax information of the pixels in the area.

6. The image processing method according to claim 1, wherein
based on the magnitude relation of the parallax information, the parallax information of the pixels in the area is generated using one of a Bezier curve and a sigmoid curve.

7. An image processing device comprising:
an acquisition portion that acquires an original image; and
a generation portion that, with respect to pixels in an area which is within the acquired original image and from which parallax information is not extracted or acquired, generates the parallax information of the pixels in the area in accordance with a magnitude relation of the parallax information of at least two pixels which are adjacent or close to the pixels in the area and which are included among pixels from which the parallax information is extracted or acquired.

8. A display device comprising:
an acquisition portion that acquires an original image;
a generation portion that, with respect to pixels in an area which is within the acquired original image and from which parallax information is not extracted or acquired, generates the parallax information of the pixels in the area in accordance with a magnitude relation of the parallax information of at least two pixels which are adjacent or close to the pixels in the area and which are included among pixels from which the parallax information is extracted or acquired; and
a display control portion that controls display of the original image using the generated parallax information.
